(19) United States
(12) Patent Application Publication
(10) Pub. No.: US 2008/0091398 A1
(43) Pub. Date: Apr. 17, 2008

(54) Method and system including time precision and display precision

(76) Inventors: Bruce Hamilton, Menlo Park, CA (US); Stanley T. Jefferson, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/580,658

(22) Filed: Oct. 13, 2006

(51) Int. Cl. G06F 17/50; G06F 9/44

(52) U.S. Cl. 703/13; 717/105

(57) ABSTRACT

A method of specifying the coordination of activities and correlation of data in a distributed system is described. A computer readable medium and a system are also described.

### CROSS-REFERENCE TO RELATED APPLICATIONS

The present application is related to U.S. patent application Ser. No. 11/429,891, entitled “Method and System Including a Graphic User Interface” to Stanley T. Jefferson and filed on May 8, 2006. This disclosure of this application is specifically incorporated herein by reference.

### BACKGROUND

The coordination of activities and correlation of data in distributed systems provide challenges to system designers and programmers. For example, it is often necessary to ensure that certain events occur at the same time, or that events occur at specific times, or that events occur at specific time intervals relative to each other, or that some minimum amount of time elapses between two events. The simultaneity and desired timing of events is often a consideration in measurement and testing and industrial automation, to name only a few applications.

Known methods for coordination of activities and correlation of data in distributed systems often treat time as data. For example, in at least one known system, time must be gathered as data and added to other time components in order to have a particular operation occur. This requires the user or programmer to actively determine certain points in time. As will be appreciated, such methods are less than user-friendly.

In addition, known programming methods do not provide precision with which events occur or the duration in which events take place. Such treatment leaves the temporal behavior of a program prone to error.

There is a need, therefore, to provide apparatuses and methods of constructing events in time that overcome at least the shortcomings of known methods discussed above.

### Defined Terminology

The terms ‘a’ or ‘an’, as used herein are defined as one or more than one.

The term ‘plurality’ as used herein is defined as two or more than two.

### SUMMARY

In accordance with an illustrative embodiment, a method of specifying the coordination of activities and correlation of data in a distributed system includes receiving a user input specifying a timing element or a graphical programming element (GPE), or both, in a frame; and providing a time precision for the GPE, or the timing element, or both.

In accordance with another illustrative embodiment, a computer readable medium is adapted to coordinate activities and correlate of data in a distributed system, the medium adapted to cause a computer to receive a user input specifying a timing element or a graphical programming element (GPE), or both, in a frame; and to provide a time precision for the GPE, or the timing element, or both.

In accordance with another illustrative embodiment, a method of specifying the coordination of activities and correlation of data in a distributed system includes: receiving a user input specifying a start time of a programming construct, or a duration of a programming construct, or both; and providing a time precision for the start time of the programming construct, or a time precision for the duration of the programming construct, or both.

### BRIEF DESCRIPTION OF THE DRAWINGS

The present teachings are best understood from the following detailed description when read with the accompanying drawing figures. The features are not necessarily drawn to scale. Wherever practical, like reference numerals refer to like features.

FIG. 1 is a conceptual diagram of a distributed system in accordance with an illustrative embodiment.

FIG. 2 is a conceptual view of a frame sequence in accordance with an illustrative embodiment.

FIG. 3 is a visual representation of a display configured with a graphical user interface (GUI) in accordance with an illustrative embodiment.

FIGS. 4A-4C are conceptual representations of display precision in accordance with an illustrative embodiment.

### DETAILED DESCRIPTION

In the following detailed description, for purposes of explanation and not limitation, illustrative embodiments disclosing specific details are set forth in order to provide a thorough understanding of the present teachings. Moreover, descriptions of well-known devices, hardware, software, firmware, methods and systems may be omitted so as to avoid obscuring the description of the illustrative embodiments. Nonetheless, such hardware, software, firmware, devices, methods and systems that are within the purview of one of ordinary skill in the art may be used in accordance with the illustrative embodiments. Finally, wherever practical, like reference numerals refer to like features.

The detailed description which follows presents methods that may be embodied by routines and symbolic representations of operations of data bits within a computer readable medium, associated processors, microprocessors, digital storage oscilloscopes, general purpose personal computers, manufacturing equipment, configured with data acquisition cards and the like. In general, a method herein is conceived to be a sequence of steps or actions leading to a desired result, and as such, encompasses such terms of art as “routine,” “program,” “objects,” “functions,” “subroutines,” and “procedures.”

The apparatuses and methods of the illustrative embodiments are described in implementations in a measurement system including one or more testing devices (e.g., oscilloscopes, waveform generators and logic analyzers). Machines that may perform the test functions according to the present teachings include those manufactured by such companies as AGILENT TECHNOLOGIES, INC., HEWLETT PACKARD, and TEKTRONIX, INC. as well as other manufacturers of test and measurement equipment.

However, the apparatuses and methods of the present teachings are more broadly applicable. For illustrative purposes, it is contemplated that the present teachings are applicable to computers, sensors, actuators, robotics, mobile phones and other technologies that require synchronization and relative timing of actions, or the absolute timing of actions, or both. Notably, the methods and apparatuses of the present teachings are contemplated for use in automated manufacture and assembly.

With respect to the software useful in the embodiments described herein, those of ordinary skill in the art will recognize that there exist a variety of platforms and languages for creating software for performing the procedures outlined herein. Certain illustrative embodiments can be implemented using any of a number of varieties of operating systems (OS) and programming languages. For example, the OS may be a commercially available OS from Microsoft Corporation, Seattle, Wash., USA, or a Linux OS. The programming language may be a C-programming language, such as C++, or Java.

In accordance with certain embodiments described herein, a graphical programming editor is implemented in Java. Moreover, the compiler is implemented in Java as well. However, those of ordinary skill in the art also recognize that the choice of the exact platform and language is often dictated by the specifics of the actual system constructed, such that what may work for one type of system may not be efficient on another system. In other applications, the choice of platform and language(s) are merely the choice of the implementer, with many fungible alternatives.

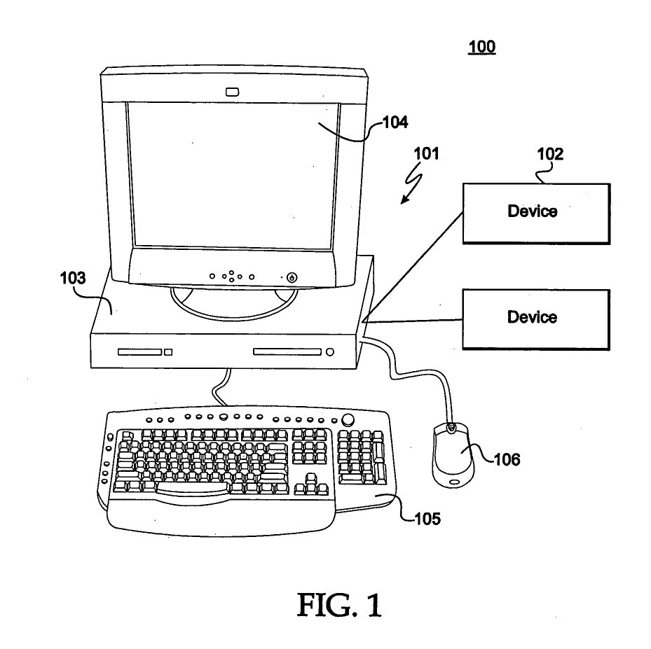

FIG. 1 is a conceptual diagram of a distributed system 100 in accordance with an illustrative embodiment. The system includes an interactive computer system (ICS) 101 and at least one device 102. The ICS 101 shown in FIG. 1 is a personal computer including a computer 103, a display 104, a keyboard 105 and a mouse 105. The computer 103 includes an OS, graphical programming editor. The graphical programming editor implemented in a programming language over the OS provides a graphical user interface (GUI). The compiler is adapted to translate the graphical program constructed with the graphical programming editor into suitable executable code for the distributed system 100. The executable code may send messages and commands to the devices 102 of the system 100. Alternatively, or additionally, the ICS 101 may provide target code for the devices 102.

The selection of a computer with a display to illustrate certain features of the present teachings is merely illustrative. In particular, the ICS 101 is portrayed as a personal computer or other similar terminal. The present teachings contemplate the ICS 101 implemented in other known devices. For example, the ICS 101 may be a portable computer, a portable digital assistant (PDA) or even a mobile telephone. Naturally, these alternative ICSs will include the requisite hardware, software and, if needed, firmware, to function in accordance with the present teachings. In many instances, present portable computers, PDA and mobile phones include such hardware and software, or will likely in the future, given the predictions of Moore's Law.

The devices 102 may be test equipment, such as oscilloscopes, optical interferometer measurement devices and logic analyzers. As noted this is merely illustrative of the application of the GUI of the illustrative embodiments. As required, some or all of the devices 102 may be connected together and some or all of the devices 102 may be connected only to the ICS 101. Such configurations are dictated by the application and are not discussed more fully to avoid obscuring the description of the embodiments.

As noted, the devices 102 may accept commands, or may be adapted to have code downloaded thereto, or may be adapted for both. Commands and/or programs may be communicated to the devices 102 via a communication channel. The devices 102 may send data to other devices 102 or ICS 101 via communication channels.

An example of a device 102 that accepts commands is an Agilent 33220A function generator. Like many test instruments, the Agilent 33220A function generator can be configured and operated using Standard Commands for Programmable Instrumentation (SCPI) commands sent over a communication channel from another device 102 or ICS 101. The Agilent 33220A function generator can also be configured and operated via IVI (Interchangeable Virtual Instrument) driver software running on a computer such as ICS 101.

Examples of devices 102 that allow for having code downloaded include, but are not limited to some computers and some mobile phones. For example, some mobile phones allow Java code to be downloaded to them to extend their capabilities.

Notably, the devices 102 that are programmable are not necessarily the same and thus the compiler is adapted to translate the graphical program into the respective target code for each respective target device 102. Moreover, instead of, or in addition to providing executable code to external devices (e.g., devices 102), the ICS 101 may provide executable code for coordination of activities and correlation of data of its functions. Moreover the executable code running on ICS 101 or a device 102 may configure or operate other devices 102 via commands or drivers (as in the case of controlling an Agilent 33220A function generator).

The ICS 101 is connected to the device(s) 102 via a wired, wireless or fiber-optic link. The link between the ICS 101 and the device 102 may be through one of a variety of standards/protocols known to those skilled in the art. For example, the link may be a local area network (LAN), a wide area network (WAN), or a wireless local area network (WLAN) to name only a few possible configurations. One skilled in the art will appreciate that one or more of a variety of standards/communications protocols may be used to implement the LAN, WAN or WLAN. It is also contemplated that the link between the ICS 101 and device(s) 102 may be carried out via a General Purpose Interface Bus (GPIB) as defined by IEEE 488, or via Universal Serial Bus (USB), or via IEEE 1394.

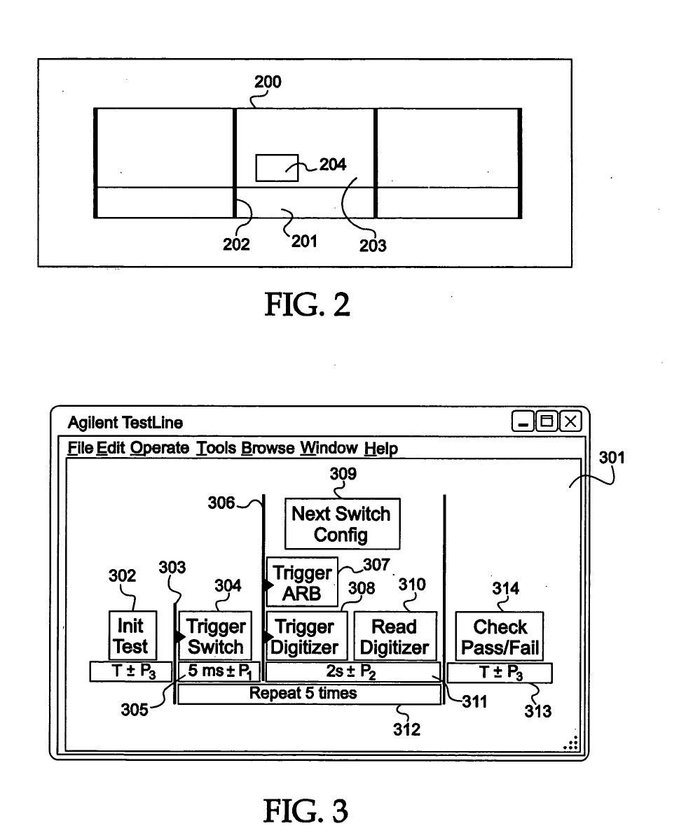

FIG. 2 is a conceptual view of a frame sequence according to an example embodiment. The representative embodiments described relate to visual editor. It is emphasized that this is merely illustrative, and that the methods described may be instantiated in other programming settings where time and temporal precision are useful.

There are three frames shown in FIG. 2, with the middle frame 200 annotated. A region 201 is provided in the frame and allows the user to input a timing element and, optionally, one or more control elements. Each timing element includes a start field and a duration field, which allow the user to optionally input a start time (s) and a duration time (t), respectively. Optionally, each timing field includes a time precision, generally identified as ±P.

A frame can also include a control element(s). Control elements enable control constructs to be associated with a frame. The control elements include control fields in which the control constructs are specified.

The inputs to the timing and control elements may be selected from a drop-down menu(s), input via a “wizard” dialog sequence, or provided as a dedicated input in the field or region 201. In an illustrative embodiment the specification of a start time literal (absolute) value would be human readable and could be based on International Standard ISO 8601. Provision is made so that the start and duration times can be expressions that reference program variables. The duration time is a logical constraint on its associated frame that can either specify that the frame has an exact duration or a duration less than some value. For example, if the duration is given as “5 ms” or “=5 ms”, then the duration of the frame is exactly 5 ms, whereas, if the duration is given as “<5 ms” then the duration of the frame can be any period of time less than 5 ms.

Furthermore, according to the present teachings, certain elements of the frame 200 that relate to time may have a specified time precision. For example, the duration of the field 201 can be set to a certain time precision (e.g., “=5 ms±0.025 ms”; or “<5 ms±0.025 ms”). Moreover, a time value (e.g., start time) may be set to an absolute time within a specified time precision (e.g., 23:54±0.5 s), or may be set to a relative time. For instance, the time value may be set relative to a timing element of a previous frame, together with a specified precision (e.g., 360.2 s±0.25 s, where the time is relative to a start time of previous synchronization edge.)

Generally, in accordance with illustrative embodiments, time precision may be specified as a deviation above and below a time value. For example, as noted above, the time precision may be of the form “+/−P”, where P is in units of time. Alternatively specified the time precision may be specified as deviation percentage above and below the time value (e.g., +/−Y %). Moreover, whether expressed as a deviation of time or percentage, the deviation is not necessarily symmetrical about the specified time. As such, the time precision may be +xx, −yy units of time or percent for cases where the bounds are not symmetrical Furthermore, the time precision of the present teachings applies to textual languages too. Illustratively, if a textual language states that event A occurs at 3:20:00; and event B occurs at 3:25:00; then precision according to one illustrative embodiment is provided in the form: A at 3:20:00+/−0.25 s; and B at 3:25:00+/−0.01 s, where the time precision noted is merely illustrative of the present embodiment.

A synchronization edge 202 is also shown in the frame 200. As described more fully herein, the synchronization edge 202 allows the user to select and attach certain functions to begin at the same time. The frame 200 includes a frame interior 203 in which one or more graphical programming element (GPE) 204 may be provided.

In the presently described embodiment, GPEs 204 are associated with a computation, procedure, function, programming control construct, graphical programming construct, event or action. Examples of GPEs that could be included are the blocks and constructs of the Agilent VEE graphical programming language. In general, the GPEs of the illustrative embodiments include a variety of graphical constructs, other than a synchronization edge, that can be attached to a synchronization edge or placed in the interior of the frame. For example, a frame sequence, which is one or more frames in a horizontal row, is also a GPE of illustrative embodiments. GPEs of the illustrative embodiments may be provided in frames via drop down menus, moveable icons, pallets of moveable icons, and other similar methods implemented via the graphical program of the illustrative embodiments.

Like timing elements, GPEs may have specified start times, or duration, or both. As such, a GPE may include a time precision. As noted, time precision specification for the GPEs and time elements may be effected using a drop-down menu(s), input via a “wizard” dialog sequence, or provided as a dedicated input in the field or region 201. As described in detail herein, the input field also may be a slider element, or a specified field.

The method of providing time precision of the representative embodiments allows the user to specify time precision for an operational program. The system can use this in various ways. For example, if the run-time environment is not able to operate to this level of precision, an error signal may be generated. Beneficially, the error signal is generated at earliest instance, such as: when the user states what system is using the program; when the program is loaded in the system; when the program begins to run on the system; or when a time-oriented command is provided.

In addition, the method of providing time precision of the representative embodiments allows the system to test temporal conditions with the specified precision. For example, if the specified precision is 1.0 ms and a deadline is missed by <0.5 ms, the deadline is considered met by the system.

In general, the time precision will be different in different parts of the system. As such, the time-aware language of the representative embodiments allows the user to state not only the time precision, but also the program elements that have this precision. For example: 1. different frames may have different time precision; 2. different frame rows may have different time precision; and 3. different levels of hierarchy may have different time precision.

In certain embodiments, the time precision is not specified at the level of timing elements. In such cases, the precision may be set as a default, such as one-half the resolution of the real-time clock of the system.

FIG. 3 is a visual representation of the display 104 configured with a graphical user interface (GUI) in accordance with an illustrative embodiment. In the illustrative embodiment, the GUI is running in a test and measurement environment. The display 104 shows a plurality of frames 301, with frames being separated by synchronization edges. Furthermore, the GPEs noted are useful in carrying out functions known to those skilled in the testing and measurements arts and are not described more fully to avoid obscuring the description of the present embodiments. Finally, the functions effected by the GUI of the illustrative embodiments are not limited to those illustrated and others known to those skilled in the art are contemplated.

The frames 301 include an initialization test element (Init Test) 302, which is followed by a first synchronization edge 303 to which a trigger switch GPE 304 is attached. The frames 301 may also include timing elements that often specify, inter alia, start times (start field), duration of a frame (duration field), as described above. For example, the frame containing trigger switch GPE 304 includes a timing element 305 having a specified duration. Moreover, the frames 301 optionally include one or more control elements that allow control constructs to be associated with a frame.

In the illustrative embodiment, the timing element 305 has a duration of 5 ms±P₁. It is contemplated that the time duration of a timing element may be specified to elapse within some period of time (e.g., <5 ms±P₁). In addition, if there is no duration specified, the associated frame may take as much time as is necessary to complete.

A second synchronization edge 306 follows on the termination of the timing element 305. The edge 306 has a trigger ARB GPE 307 (as is known, an arbitrary waveform generator is often referred to as an ‘ARB’) and a trigger digitizer GPE 308 attached thereto. As such, 5.0 ms±P₁ after the initiation of the first synchronization edge 303, the ARB and digitizer are simultaneously initiated. Moreover, the synchronization edge may be set to occur at an absolute time within a specified time precision.

A Next Switch Configuration GPE 309 is provided after the commencement of the GPEs 307,308; and a Read Digitizer GPE 310 follows the completion of GPE 308. As shown, a timing element 311 having a duration of 2 s±P₂ (where P₂ does not necessarily equal P₁) is provided and specifies the time allotted for the completion of GPEs 307-310. A control element 312 is provided that requires the test sequence beginning with the trigger switch GPE 304 and terminating with the expiration of the duration of timing element 311 to be repeated five (5) times.

In certain embodiments, timing elements 313 have a specified duration field, although the timing elements 313 may have an unspecified duration field. As such, the corresponding frame terminates when all of the GPEs in the frame terminate. A check pass/fail GPE 314 is provided in one of the frames 301 as shown. Thus, after the quintuple repetition of the steps described above, the check pass/fail sequence is initiated. Alternatively, the timing elements 313 may have a specified duration (shown as T), with a specified time precision ±P₃. Notably, the time precisions of the timing elements 305, 311 and 313 are not necessarily the same.

According to representative embodiments, the time precision is specified by the user, for various elements of the frame 301. In an embodiment, the time precision is specified by the user when constructing the elements of the frame, in accordance with the teachings of the referenced application to Jefferson. For example, in specifying timing element 305, the user specifies the time 5 ms and the time precision ±P₁.

Certain aspects of the specification of time precision are notable. First, as with the specification of the start time, or duration, or both of time elements and GPEs, the user is free to set the desired time precision of these elements in a frame. Thus, in keeping with the above illustration, P₁ does not necessarily equal P₂ or P₃, although it may equal one or both. Similar permutations are contemplated. Moreover, as noted above the time-aware language of the representative embodiments allows the user to state not only the time precision, but also the program elements that have this precision. In addition, the various ways of expressing the time precision (e.g., asymmetrically, as a percentage of time) also may be implemented.

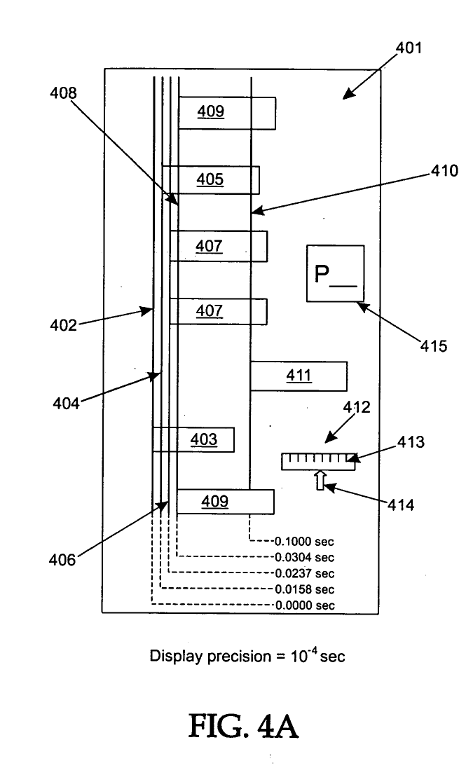

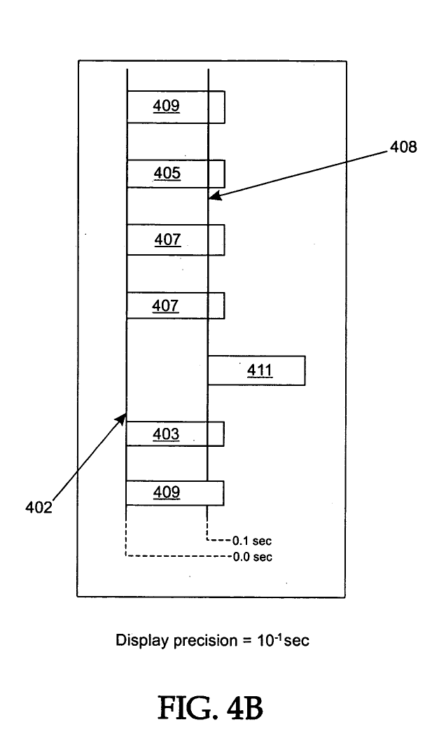

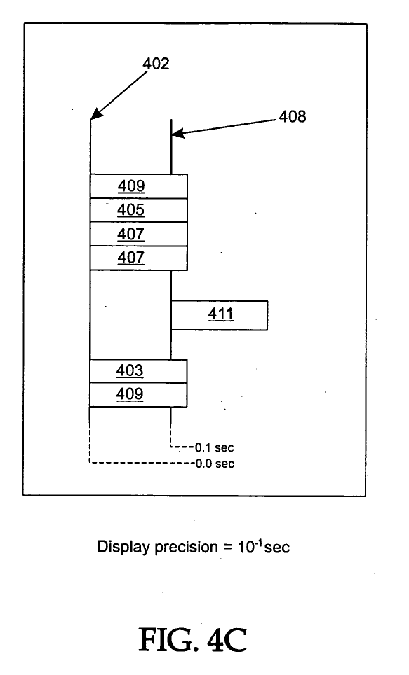

As will be appreciated, one useful aspect of the present teachings is the facility of specifying the time precision for various temporally based elements. FIG. 3 depicts the specification of time precision with respect execution and run-time, for example, in accordance with an illustrative embodiment. While the foregoing describes the usefulness of specifying the precision of the start time and duration of various program elements, a separate use for explicit precision lies in the way a program is displayed to the programmer. As used herein, this referred to as “display precision.” Display precision according to certain illustrative embodiments, is described in connection with FIG. 4A-4C.

FIGS. 4A-4C are conceptual representations of the display 104 configured with a graphical user interface (GUI) in accordance with an illustrative embodiment.

As noted previously, the present embodiments describes display precision, which allows the user to set and view the display to a desired level of precision. The display precision may be implemented according to the teachings of the referenced application to Jefferson. Moreover, the precision described in conjunction with the representative embodiment of FIGS. 4A-4C is a different kind of thing from the time precision set in a run-time environment and described in conjunction with FIGS. 2-3B. Beneficially, the representative embodiment described in conjunction with FIG. 4A-4C reduces visual clutter on the display.

In FIG. 4A, a frame 401 is shown having a plurality of elements 403,405,407,409 and 411. These elements may be GPEs or timing elements as described previously. It is emphasized that while the display precision is described as graphical times, and thus affects graphical times of a display, the present teachings are applicable to numeric times as well. In particular, the present teachings contemplate that display precision affects numeric (non-graphical) times as well. For example, if a textual language indicates that an event ‘A’ is at 3:20:0.00000001; and event B is at 3:19:59.999999998, the programmer may wish to view the noted times at their full precision. Alternatively, the programmer may find the program easier to understand if written as: A occurs at 3:20; and B occurs at 3:20. Thus, the method, computer-readable medium and system of the illustrative embodiments usefully provides a progammer the power to ‘zoom in and out’ on the time detail in this way.

In FIG. 4A, the display precision has been set to 10⁻⁴ s. Start times 402, 404, 406, 408 and 410 are shown as vertical lines within the frame and the respective start time of each is shown. As such, element 403 is has start time 402 at 0.0000 s; elements 405 have start time 404 at 0.0158 s; elements 407 have start time 406 at 0.0237; elements 409 have a start time 408 at 0.0304 s; and elements 411 has start time 410 at 0.1000 s. As will be appreciated, the frame 401 includes a relatively high degree of visual clutter.

FIG. 4B shows frame 401 with a display precision of 10⁻¹ s. Notably, the start times of elements 403, 405, 407, 409, 411 specified in FIG. 4A apply. However, because the display precision in FIG. 4B is set to be lower than that of FIG. 4A, two start times, namely 402 and 410, only are needed in view of the lower display precision. Thus, elements 403, 405, 407, 409 are aligned with start time 402; and element 411 remains aligned with start time 410. As will be appreciated, the visual clutter is reduced by reducing the display precision.

FIG. 4C shows frame 401 with elements 403,405,407,409 and 411. The display precision is unchanged from FIG. 4B. However, elements 403,405,407 and 409 having start time 402 are vertically compressed, further reducing the visual clutter.

The embodiments described focus on the display precision with respect to start times. Beneficially, the display precision may be applied to the duration of an element. In particular, when the display precision is set, the length of elements 403,405,407,409 and 411 having the same duration, within the display precision, may be adjusted to be equal. Similarly, elements having different durations, within the specified display precision, have different lengths.

In representative embodiments, the visual editor is adapted to provide the aligning and element length. In particular, when the display precision is set by the user (e.g., using a slider or field, or other similar method), the visual editor determines if, within the set display precision, a plurality of elements have start times that overlap, or if the plurality of elements have durations that overlap, or both. Based on this determination and as described in connection with FIGS. 4A-4C, the visual editor displays the elements as being aligned, or of equal length, or both, respectively. By contrast, if within the set display precision, a plurality of elements does not have the same start times or duration, the visual editor displays the elements as offset (sequential), or having different lengths, or both, respectively. Moreover, the display precision described in conjunction with elements of a frame may be applied to frames as well. For instance, after display precision is set, if a plurality of frames have the same start time, these are displayed as aligned.

As shown, a slider 412 includes a first level of precision P1 and a second level of precision P2. The levels P1 and P2 may be selected by the user via one or more of the known elements noted above. Gradations 413 provide a linear or non-linear scale of the precision between the first and second levels of precision. A pointer 414 is movable between the first and second levels of precision, allowing the user to select a desired level of precision.

The slider 412 may be one of a number of sliders within one or more frames 401. Notably, each frame may have a set display precision for all elements in the frame. Alternatively, each type of timing element or GPE, or each specific type of timing element or GPE may be provided with a respective slider. In this way, display precision may be provided as needed.

In an alternative embodiment, the display precision may be set in a field 415. In this manner, the user can specify the desired display precision. Like the slider 410, there may be a plurality of fields 415 provided. There may be one field for each frame; or one field for one type of timing element or GPE; or specific fields for specific types of timing elements or GPEs. In yet another alternative embodiment, the display precision may be selected from a list such as via a drop-down menu (not shown). Regardless of the method selected, the display precision may be applied to frames, GPEs and timing elements in a similar manner as described in connection with the slider 412.

As will be appreciated, the embodiments described in conjunction with FIGS. 4A-4C allow the user to reduce or substantially eliminate visual clutter on the display. If the user does not specify any display precision, the system can use a convenient default value. If the mapping to a particular run-time environment is known, the system can use the precision available in that environment.

In view of this disclosure it is noted that the various methods and devices described herein can be implemented in hardware and software. Further, the various methods and parameters are included by way of illustrative only and not in any limiting sense. While certain useful aspects of the method of the illustrative embodiments have been described, there are clearly modifications that will be apparent to one of ordinary skill in the art having had the benefit of the present disclosure. In view of this disclosure, those skilled in the art can implement the present teachings in determining their own techniques and needed equipment to implement these techniques, while remaining within the scope of the appended claims.

1. A method of specifying the coordination of activities and correlation of data in a distributed system, the method comprising:
receiving a user input specifying a timing element or a graphical programming element (GPE), or both, in a frame; and
providing a time precision for the GPE, or the timing element, or both.

2. A method as claimed in claim 1, further comprising specifying at least one other timing element in the frame and specifying another time precision for the at least one other timing element.

3. A method as claimed in claim 1, further comprising specifying at least one other GPE in the frame and specifying another time precision for the at least one GPE.

4. A method as claimed in claim 1, further comprising specifying a display precision.

5. A method as claimed in claim 4, further comprising providing an input adapted to set the display precision.

6. A method as claimed in claim 5, wherein the input is a slider, an input field or a drop-down menu on the display.

7. A computer readable medium adapted to coordinate activities and correlate data in a distributed system, the medium adapted to cause a computer to:
receive a user input specifying a timing element or a graphical programming element (GPE), or both, in a frame; and
provide a time precision for the GPE, or the timing element, or both.

8. A computer readable medium as claimed in claim 7, wherein the medium is further adapted to:
specify at least one other timing element in the frame and specify another time precision for the at least one other timing element.

9. A computer readable medium as claimed in claim 7, wherein the medium is further adapted to: specify at least one other GPE in the frame and specify another time precision for the at least one GPE.

10. A computer readable medium as claimed in claim 7, wherein the medium is adapted to specify a display precision.

11. A computer readable as claimed in claim 11, wherein the medium is adapted to provide an input adapted to set the display precision.

12. A computer readable medium as claimed in claim 11, wherein the input is a slider, an input field or a drop-down menu on the display.

13. A method of specifying the coordination of activities and correlation of data in a distributed system, the method comprising:
receiving a user input specifying a start time of a programming construct, or a duration of a programming construct, or both; and
providing a time precision for the start time of the programming construct, or a time precision for the duration of the programming construct, or both.

14. A method as claimed in claim 13, wherein the time precision of the start time is not symmetric about a time value of the start time.

15. A method as claimed in claim 13, wherein the time precision of the duration is not symmetric about a time value of the duration.

16. A method as claimed in claim 13, wherein the time precision of the start time and the time precision of the duration are expressed in units of time, or as a percentage of time.

17. A computer readable medium adapted to specify the coordination of activities and correlation of data in a distributed system, the medium adapted to cause a computer to:
receive a user input specifying a start time of a programming construct, or a duration of a programming construct, or both; and
provide a time precision for the start time of the programming construct, or a time precision for the duration of the programming construct, or both.

18. A computer readable medium as claimed in claim 17, wherein the time precision of the start time is not symmetric about a time value of the start time.

19. A computer readable medium as claimed in claim 17, wherein the time precision of the duration is not symmetric about a time value of the duration.

20. A computer readable medium as claimed in claim 17, wherein the time precision of the start time and the time precision of the duration are expressed in units of time, or as a percentage of time.
